(19) United States
(12) Patent Application Publication
(10) Pub. No.: US 2023/0270054 A1
(43) Pub. Date: Aug. 31, 2023

(54) APPARATUS AND METHODS FOR BEE CONTROL BACKGROUND

(71) Applicant: MJNN LLC, South San Francisco, CA (US)

(72) Inventors: Kevin GRAUBERGER, South San Francisco, CA (US); Aunders HALLSTEN, South San Francisco, CA (US); Damon SMITH, South San Francisco, CA (US); Lucas WOODBURY, South San Francisco, CA (US); Michael BALDWIN, South San Francisco, CA (US)

(21) Appl. No.: 18/017,353

(22) PCT Filed: Jul. 22, 2021
(86) PCT No.: PCT/US2021/042685

§ 371 Date: Jan. 20, 2023

Related U.S. Application Data
(60) Provisional application No. 63/055,115, filed on Jul. 22, 2020.

(51) Int. Cl. A01G 9/24

(52) U.S. Cl. CPC A01G 9/249; A01G 9/246

(57) ABSTRACT

Embodiments of the present disclosure relate to apparatus and methods for pollination within a controlled agricultural environment. In one example, a pollination system (300) includes a pollination chamber (322) having air curtains (302, 304) and walls (402, 404, 406) defining a volume, a grow tower conveyance system, and ultra-violet light sources (314, 318, 330, 334) for illuminating the pollination volume. Pollinators, such as bees or the like, are positioned within the volume of the pollination chamber (322) and the light sources (314, 318, 330, 334) are utilized to control and encourage pollination and pollinator movement with the pollination chamber (322).

### BACKGROUND

### Field

Embodiments of the present disclosure generally relate to apparatus and methods for plant pollination. More specifically, embodiments of the present disclosure relate to apparatus and methods for bee management.

### Description of the Related Art

Bees are known for their role in pollination of flowering plants. As pollination vectors, bees move pollen from the male anther of a flower to the female stigma of the flower which facilitates fertilization of the ovules in the flower by the male gametes from the pollen grains. Bees are often considered a keystone species due to their importance in preventing collapse of various ecosystems. In addition to the sustainability of various ecosystems, bees are also fundamental in the pollination of numerous commercially grown crops.

Conventional outdoor agricultural producers rely on bees for pollination of their crops. The bees may be naturally present in the agricultural environment or beehives may be brought to and placed in the agricultural environment to supplement native bee populations when pollination is needed. While bees are well suited for conventional outdoor agricultural environments, the utilization of bees in developing indoor agricultural environments can be problematic. For example, restricting the movement of bees to facilitate pollination can be difficult and individuals operating within a bee-laden environment are exposed to an increased risk of undesirable human-bee interactions, such as bee stings or the like. Moreover, efficient pollination utilizing bees in an indoor agricultural environment may be challenging and reduce the throughput or yield of various crops.

Accordingly, what is needed in the art are improved apparatus and methods for bee management within indoor agricultural environments.

### SUMMARY

In one embodiment, a pollination system is provided. The system includes a grow line having a plurality of grow towers disposed thereon and a pollination chamber. The pollination chamber includes a plurality of walls at least partially defining a volume, a first flow generator positioned adjacent to the plurality of walls, a second flow generator positioned adjacent to the plurality of walls and opposite the first flow generator, and a plurality of light sources disposed within the pollination chamber.

In another embodiment, a pollination system is provided. The system includes a plurality of walls, a first flow generator disposed adjacent to the plurality of walls and configured to generate a first air curtain, a second flow generator disposed adjacent to the plurality of walls and configured to generate a second air curtain, the second air curtain disposed opposite the first air curtain. The plurality of walls, the first air curtain, and the second air curtain define a volume and a plurality of light sources are disposed in the volume.

In yet another embodiment, a pollination system is provided. The system includes a grow line having a plurality of grow towers disposed thereon and a pollination chamber. The pollination chamber includes a plurality of walls at least partially defining a volume, a first flow generator positioned adjacent to the plurality of walls, a second flow generator positioned adjacent to the plurality of walls and opposite the first flow generator, and a plurality of light sources disposed within the pollination chamber. The plurality of light sources include a plurality of light source pairs. A first light source of a pair is disposed above the grow towers, a second light source of the pair is disposed below the grow towers, and the plurality of light source pairs are positioned within the volume along a travel path of the grow towers.

In yet another embodiment, a plant pollination method is provided. The method includes positioning pollinators in a pollination chamber, activating a plurality of air curtains to define an enclosed volume of the pollination chamber, moving one or more grow towers through a first air curtain of the plurality of air curtains, illuminating the grow towers with ultraviolet light in the volume of the pollination chamber, and moving the grow towers through a second air curtain of the plurality of air curtains.

In yet another embodiment, a plant pollination method is provided. The method includes positioning pollinators in a pollination chamber, activating a plurality of air curtains to enclose a volume of the pollination chamber, deactivating a first air curtain of the plurality of air curtains, moving one or more grow towers into the pollination chamber, activating ultraviolet lights and illuminating the grow towers, reactivating the first air curtain, deactivating the ultraviolet lights, deactivating a second air curtain of the plurality of air curtains, moving the grow tower out of the pollination chamber, and reactivating the second air curtain.

In yet another embodiment, a plant pollination method is provided. The method includes positioning pollinators in a pollination chamber, activating a first air curtain and a second air curtain to define an enclosed volume of the pollination chamber, activating a first ultraviolet light adjacent to the second air curtain, deactivating the first air curtain, moving one or more grow towers into the pollination chamber, reactivating the first air curtain, activating one or more additional ultraviolet lights, deactivating the one or more additional ultraviolet lights and the first ultraviolet light adjacent to the second air curtain, activating a second ultraviolet light adjacent to the first air curtain, deactivating the second air curtain, moving the grow towers out of the pollination chamber, and reactivating the second air curtain.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a schematic perspective view of a controlled environment agriculture system according to an embodiment of the disclosure.

FIG. 2 illustrates a perspective view of a portion of a grow line with grow towers according to an embodiment of the disclosure.

FIG. 3A is a schematic side view of a pollination system of a controlled environment agriculture system according to an embodiment of the disclosure.

FIG. 3B is a schematic side view of a pollination system of a controlled environment agriculture system according to an embodiment of the disclosure.

FIG. 4 is a schematic end view of the pollination system of either FIGS. 3A or 3B according to an embodiment of the disclosure.

FIG. 5 is a schematic end view of the pollination system of wither FIGS. 3A or 3B according to an embodiment of the disclosure.

FIG. 6 is a schematic side view of a pollination system of a controlled environment agriculture system according to an embodiment of the disclosure.

FIG. 7 is a block diagram illustrating operations of a pollinator control method according to an embodiment of the disclosure.

FIG. 8 is a block diagram illustrating operations of a pollinator control method according to an embodiment of the disclosure.

FIG. 9 is a block diagram illustrating operations of a pollinator control method according to an embodiment of the disclosure.

FIG. 10 illustrate a schematic plan view of multiple pollination stations according to an embodiment of the disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure relate to apparatus and methods for pollination within a controlled agricultural environment. In one example, a pollination system includes a pollination chamber having air curtains and walls defining a volume, a grow tower conveyance system, and ultra-violet light sources for illuminating the pollination volume. Pollinators, such as bees or the like, are positioned within the volume of the pollination chamber and the light sources are utilized to control and encourage pollination and pollinator movement with the pollination chamber.

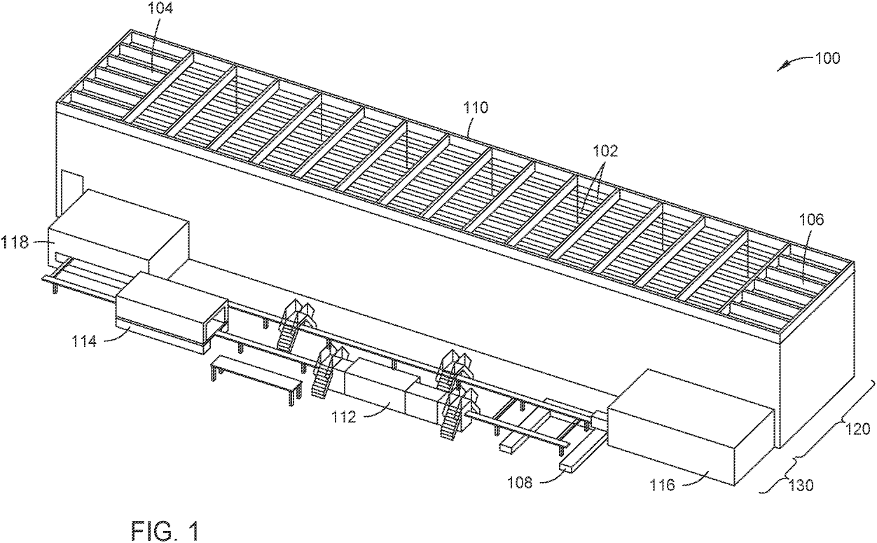

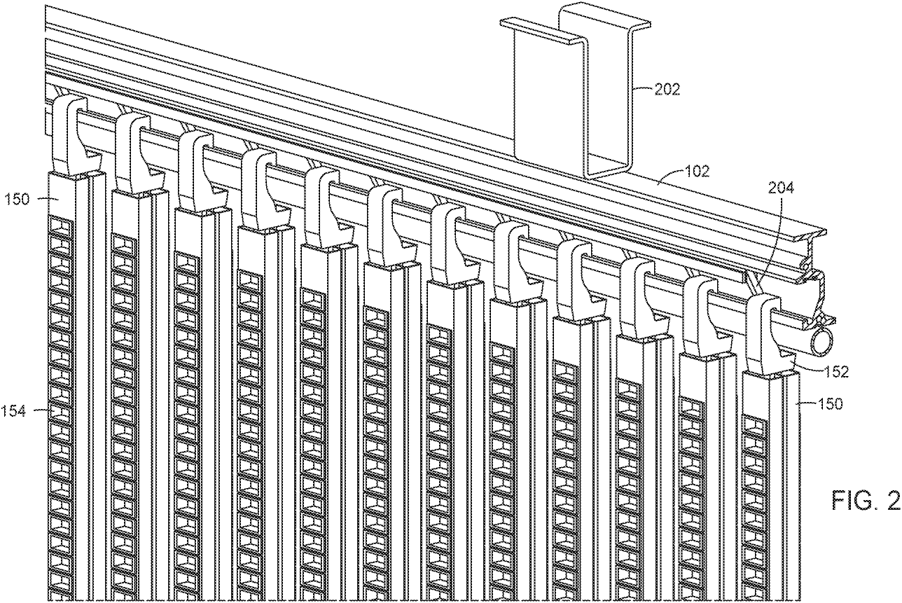

FIG. 1 illustrates a schematic perspective view of a controlled environment agriculture system 100. The system 100 is configured for high-density growth and crop yield and includes an environmentally controlled growing chamber 120 and a vertical tower conveyance system 110 disposed within the growing chamber 120. The conveyance system 110 is operable to convey grow towers 150, described in greater detail with respect to FIG. 2, with crops/plants therein through the growing chamber 120. The crops or plants grown within the system 100 may exhibit gravitropic, geotropic, and/or phototropic growth characteristics. The crops or plants may vary considerably and include, but are not limited to, leaf vegetables, fruiting vegetables, flowering crops, fruits, and tubers, among others. The system 100 may be configured to grow a single crop or plant type at a time or grow multiple crop or plant types concurrently.

The system 100 also includes additional conveyance systems, such as a central processing system 130, for moving the grow towers in a circuit or pathway within the system 100 throughout the crop or plant growth cycle. The central processing system 130 includes one or more conveyance mechanisms for directing grow towers to stations for loading plant plugs into, and harvesting crops from, the grow towers. For example, the central processing system 130 includes a harvester station 108, a washing station, 112, and a transplanter station 114. The harvester station 108 removes crops from the grow towers and deposits harvested crops into food-safe containers which may then be conveyed to post-harvest facilities (e.g. preparation, washing, packaging, storage, etc.).

In the illustrated embodiment, various stations of the central processing system 130 operate on grow towers disposed in a horizontal orientation. A pick-up station 118, and associated control logic, includes a robot operable to releasably grasp a grow tower oriented horizontally from a loading location, rotate the grow tower into a vertical orientation, and attach the grow tower to a transfer station for insertion into a selected grow line 102 of the growing chamber 120. At the other end of the growing chamber 120, a laydown station 116, and associated control logic, is operable to releasably grasp and move a vertically oriented grow tower from a buffer region, rotate the grow tower to a horizontal orientation, and position the grow tower on a conveyance system for loading into the harvester station 108. The stations 118, 116 each include a robotic arm, such as a six-degree of freedom robotic arm with end effectors for grasping the grow towers.

The growing chamber 120 also includes automated loading and unloading mechanisms for inserting grow towers into selected grow lines 102 and unloading grow towers from the grow lines 102. In one implementation, a load transfer conveyance mechanism 104 includes a powered and free conveyor system that conveys carriages loaded with grow towers from the pick-up station 118 to a selected grow line 102. The load transfer conveyance mechanism 104 also includes one or more actuators that push the grow towers onto a grow line 102. Similarly, an unload transfer conveyance mechanism 106 includes one or more actuators that push or pull the grow towers from the grow lines 102 into a carriage of another powered or free conveyor mechanism, which conveys the carriages from the grow line 102 to the laydown station 116.

The circuit or pathway includes a staging area for loading the grow towers into and out of the conveyance system 110. The conveyance system 110 within the growing chamber 120 is configured to suspend or otherwise support and translate one or more grow towers along a plurality of grow lines 102. Each grow tower is configured to contain plant growth media that supports a root structure of at least one crop or plant growing therein. The grow towers releasably attach to the grow lines 102 in a substantially vertical orientation and move along the grow lines 102 during a growth phase of the plant. The conveyance system 110 and central processing system 130 are arranged in a production circuit under the control of one or more computing and/or control systems.

The growing chamber 120 includes light emitting sources positioned at various locations along and between the grow lines 102 of the conveyance system 110. The light emitting sources can be positioned laterally relative to the grow towers in the grow lines 102 and configured to emit light toward faces of the grow towers that include openings from which the plants grow. In one example, the light emitting sources are light emitting diodes (LED). The light emitting sources may be a plurality of LEDs arranged in a bar-like structure which is positioned in a vertical orientation to emit light laterally along an entire length of the grow tower. Multiple LED light bar structures are arranged in the growing chamber 120 along and between the grow lines 102. Other lighting configurations are also contemplated. For example, the LED light bar structures may be arranged horizontally between the grow lines 102. In certain embodiments, the LED light bar structures are water-cooled.

The growing chamber 120 also includes a nutrient supply system configured to supply an aqueous crop nutrient solution to the crops disposed in the grow towers as the grow towers translate through the growing chamber 120. The nutrient supply system provides an aqueous crop nutrient solution to a top of the grow towers and gravity causes the nutrient solution to travel down the vertically-oriented grow towers to the crops disposed along a length of the grow towers.

The growing chamber 120 also includes an airflow source which is configured to direct airflow in a direction lateral to growth of the crops and through an under-canopy of each plant to disturb a boundary layer of the under-canopy of the plant. In another implementation, airflow is directed from the top of the canopy or orthogonal to the direction of plant growth. The growing chamber 120 also includes a control system and associated sensors for regulating at least one growing condition, such as air temperature, airflow velocity, relative air humidity, and ambient carbon dioxide gas content. The control system may further include sub-systems such as HVAC units, chillers, fans, and associated ducting and air handling apparatus.

The grow towers include various identifying attributes, such as bar codes or radio frequency identification (RFID) tags, to enable sensing and location detection of each grow tower. The system 100 includes corresponding sensors and programming logic for tracking the grow towers during various stages of the crop production cycle and for controlling one or more conditions of the growth environment. The operation of the controls systems and the length of time the grow towers remain in the growth environment can vary depending on a variety of factors, such as crop type, desired crop maturity, and the like.

In operation, grow towers, with newly transplanted crops or seedlings disposed therein, are transferred from the central processing system 130 into the conveyance system 110. The conveyance system 110 moves the grow towers to predefined positions along respective grow lines 102 within the growing chamber 120 in a controlled manner. Within the growing chamber 120, the crops disposed in the grow towers are exposed to the controlled conditions of the growth environments, such as light, temperature, humidity, airflow, nutrient supply, etc. The control systems of the controlled environment agriculture system 100 are capable of automated adjustments to the growth environment to improve growing conditions and improve various crop attributes, such as crop yields, crop visual appeal, and crop nutrient content. When the crops are ready for harvesting, the grow towers are transferred from the conveyance system 110 to the central processing system 130 for harvesting and other processing operations.

FIG. 2 illustrates a perspective view of a portion of the grow line 102 with the grow towers 150 according to an embodiment of the disclosure. As illustrated, a plurality of the grow towers 150 are arranged in parallel along the grow line 102. Each grow tower 150 includes a plurality of grow sites 154 distributed along opposing faces of the grow tower 150. In operation, the transplanter station 114 transplants seedlings into empty grow sites 154 of the grow towers 150 where the seedlings remain and mature until the plant is ready for harvesting. The grow line 102 supports the plurality of grow towers 150 and the grow line 102 is supported by a bracket 202 which may be coupled to a superstructure, such as a frame or a facility structure. Hooks 152 couple the grow tower 150 to the grow line 102 and support the grow towers 150 in a vertical orientation as the grow towers 150 are translated along the grow line 102. A conveyance mechanism 204 engages the hooks 152 to enable movement of the grow towers 150 along the grow line 102.

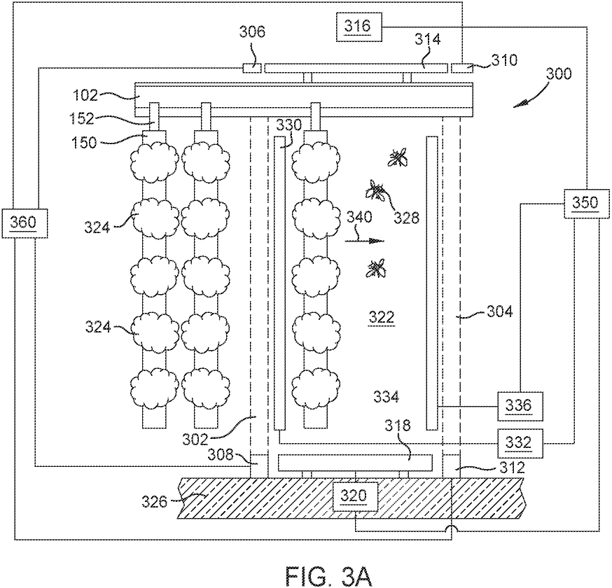

FIG. 3A is a schematic side view of a pollination system 300 of the controlled environment agriculture system 100 according to an embodiment of the disclosure. The system 300 may be implemented within the tower conveyance system 110 or in a different region of the system 100. In one example, the system 300 is implemented at a location within the tower conveyance system 110 between the load transfer conveyance system 104 and the unload transfer conveyance system 106. In another example, the system 300 is implemented in a region of the system 100 which is adjacent to or adjoining the tower conveyance system 110.

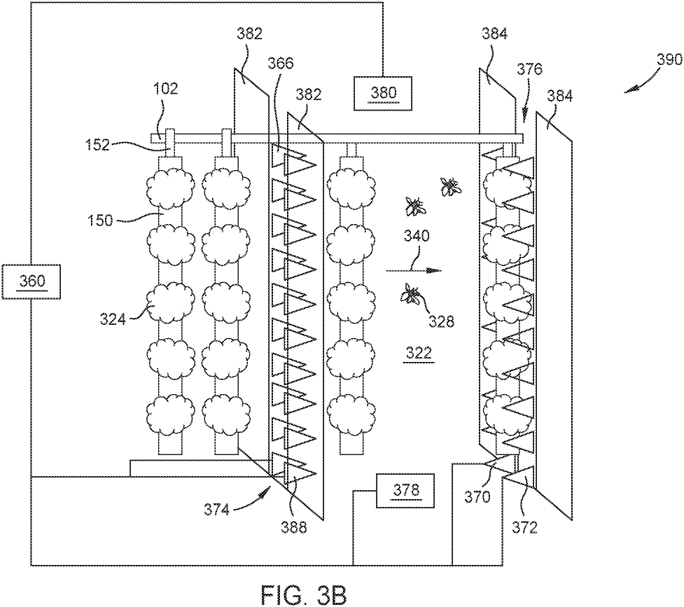

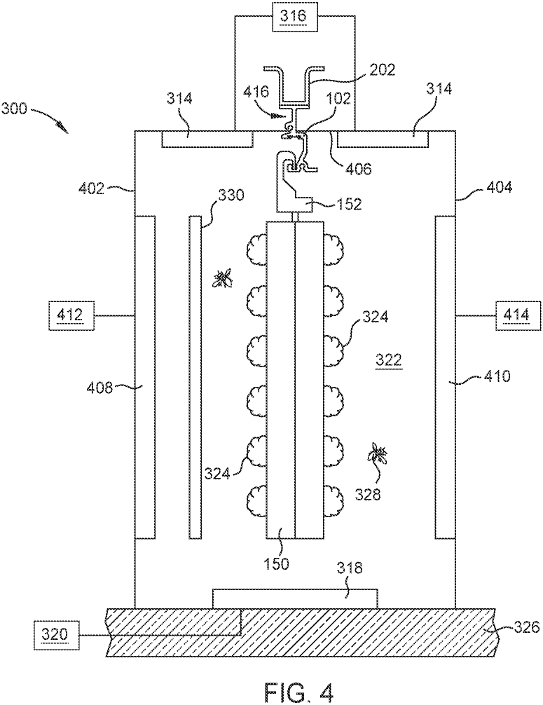

The system 300 is integrated with the grow lines 102 and the grow towers 150. The system 300 includes a plurality of air curtains 302, 304, walls 402, 404, 406 (illustrated in FIGS. 4 and 5), and light sources 314, 318, 330, 334. The air curtains 302, 304, walls 402, 404, 406, and floor 326 define a volume 322 within which pollination is performed by pollination vectors, such as bees 328. While bees 328 are illustrated and described as the pollination vectors herein, it is contemplated that other pollinators may be utilized in accordance with the embodiments described herein. Other pollinators include, but are not limited to, butterflies, beetles, flies, wasps, moths, and other flying insects capable of performing pollination.

The volume 322 is maintained in a manner to prevent escape of the bees 328 from the volume 322. The air curtains 302, 304 are jetted flows of air which create an air dam or fluid boundary that prevents or substantially reduces the probability of bees 328 escaping from the volume 322. In one embodiment, a first air curtain 302 is generated to create a wall of the volume 322. The first air curtain 302 is generated by a first flow generator 306. The first flow generator 306 generally includes an air intake, a blower or fan, a pressure chamber, and a nozzle. The first air curtain 306 is generated when the blower pulls in air through the air intake, pressurizes the pressure chamber, and expels the pressurized air through the nozzle. The air is directed in a specified directions and flows at a velocity sufficient to create a fluid barrier between the volume 322 and surrounding environment.

A first flow receiver 308 is disposed opposite and vertically aligned with the first flow generator 306. The first flow receiver 308 generally includes an intake grate, a hood, and ducting to direct air flow generated by the generator 306 to an exhaust. In one embodiment, the first flow generator 306 is positioned adjacent to the grow line 102. For example, the first flow generator 306 may be positioned above the grow line 102 or below the grow line 102 depending upon the desired implementation. The first flow receiver 308 is positioned on or adjacent to the floor 326. In one embodiment, the first flow receiver 308 is optional. In this embodiment, the first air curtain 302 generated by the first flow generator 306 flows in a substantially downward vertical orientation until the first air curtain 302 contacts the floor 326. At this point, the first air curtain 302 is dissipated in a direction substantially normal to the vertical flow direction generated by the first flow generator 306.

In another embodiment, the positions of the first flow generator 306 and the first flow receiver 308 are inverted. In this embodiment, the first flow generator 306 is positioned on or adjacent to the floor 326 and the first flow receiver 308 is positioned adjacent to the grow line 102. In this embodiment, the first flow generator 306 and the first flow receiver 308 are substantially vertically aligned. In certain embodiments when the first flow generator 306 is positioned on or adjacent to the floor 326, the first flow receiver 308 is optional. In these embodiments, the first air curtain 302 generated by the first flow generator 306 flows in a substantially upward vertical orientation until the first air curtain 302 contacts the grow line 102 or the wall 406 (See FIG. 4). At this point, the first air curtain 302 is dissipated in a direction substantially normal to the vertical flow direction generated by the first flow generator 306.

The second air curtain 304 is generated to create a wall of the volume 322 opposite and spaced from the first air curtain 302. The second air curtain 304 and first air curtain 302 are spaced apart from one another a distance greater than a width of the grow tower 150. In one embodiment, the air curtains 302, 304 are spaced a distance between about two times a width of the grow tower 150 and about 100 times a width of the grow tower 150. The second air curtain 304 is generated by a second flow generator 310. The second flow generator 310 is similar to the first flow generator 306. Accordingly, the second flow generator 310 creates the second air curtain 304 which flows in a specified direction and with velocity sufficient to create a fluid barrier between the volume 322 and surrounding environment.

A second flow received 312 is disposed opposite and vertically aligned with the second flow generator 310. The second flow receiver 312 is similar to the first flow receiver 308. In one embodiment, the second flow generator 310 is positioned adjacent to the grow line 102. For example, the second flow generator 310 may be positioned above the grow line 102 or below the grow line 102 depending upon the desired implementation. The second flow receiver 312 is positioned on or adjacent to the floor 326. In one embodiment, the second flow receiver 312 is optional. In this embodiment, the second air curtain 304 generated by the second flow generator 310 flows in a substantially downward vertical orientation until the second air curtain 304 contacts the floor 326. At this point, the second air curtain 304 is dissipated in a direction substantially normal to the vertical flow direction generated by the second flow generator 310.

In another embodiment, the positions of the second flow generator 310 and the second flow receiver 312 are inverted. In this embodiment, the second flow generator 310 is positioned on or adjacent to the floor 326 and the second flow receiver 312 is positioned adjacent to the grow line 102. In this embodiment, the second flow generator 310 and the second flow receiver 312 are substantially vertically aligned. In certain embodiments when the second flow generator 310 is positioned on or adjacent to the floor 326, the second flow receiver 312 is optional. In these embodiments, the second air curtain 304 generated by the second flow generator 310 flows in a substantially upward vertical orientation until the second air curtain 304 contacts the grow line 102 or the wall 406 (See FIG. 4). At this point, the second air curtain 304 is dissipated in a direction substantially normal to the vertical flow direction generated by the second flow generator 310.

In other embodiments, the air curtains 302, 304 are implemented utilizing different fluid flow directions. For example, the first flow generator 306 is disposed above the grow towers 150 and the first flow receiver 308 is disposed below the grow towers 150 while the second flow generator 310 is positioned below the grow towers 150 and the second flow receiver 312 is positioned above the grow towers 150. In an alternate example, the first flow generator 306 is disposed below the grow towers 150 and the first flow receiver 308 is disposed above the grow towers 150 while the second flow generator 310 is positioned above the grow towers 150 and the second flow receiver 312 is positioned below the grow towers 150. In both example, the flow receivers 308, 312 are optional.

In an alternate embodiment, the first air curtain 302 and the second air curtain 304 are replaced with sliding doors. Accordingly, the flow generators 306, 310 and the flow receivers 308, 312 are replaced with door tracks and actuators which enable opening and closing of the sliding doors. In this embodiment, the sliding doors occupy substantially the same area as the air curtains 302, 304 when the doors are in a closed position.

Each of the flow generators 306, 310 and flow receivers 308, 312 are in communication with a controller 360. The air curtains 302, 304 are controlled by the controller 360 that is generally designed to facilitate the control and automation of the air curtains 302, 304 within the system 300. The controller 360 includes, but is not limited to, a central processing unit (CPU), memory, and support circuits. The CPU may be one of any form of computer processor used in industrial settings for controlling various system functions, such as activation and deactivation of the air curtains 302, 304, coordination and control of system processes, and support hardware (e.g., sensors, robots, motors, actuators, etc.), and process monitoring. The memory is connected to the CPU, and may be one or more of a readily available memory, such as random access memory (RAM), read only memory (ROM), floppy disk, hard disk, solid state, flash memory, magnetic memory, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the controller 360 determines operation of the air curtains 302, 304. The program is software readable by the controller 360 that includes code to perform tasks relating to activation, deactivation, monitoring, and coordination of the air curtains 302, 304 with other aspects of the system 300. For example, the controller 360 includes program code that synchronizes activation and deactivation of the air curtains 302, 304 to enable movement of grow towers 150 into and out of the volume 322. In another example, the controller 360 includes program code which analyzed input from cameras or motion sensors to activate the air curtains 302, 304 depending upon the proximity of the bees to the air curtains 302, 304 to maintain the bees within the volume 322.

The system 300 include the light sources 314, 318, 330, 334 which are utilized to illuminate the volume 322 and more specifically, plants 324 growing in the grow towers 150. The light sources 314, 318, 330, 334 are ultraviolet lights and emit electromagnetic radiation typically within a wavelength range of between about 10 nm to about 400 nm. The light sources 314, 318, 330, 334 may be light emitting diodes, fluorescent lamps, incandescent lamps, mercury-vapor lamps, lasers, or blacklights utilizing various lamp types and a filter to facilitate ultraviolet light emission.

Bees have photoreceptors in their eyes that enable enhanced sensitivity to electromagnetic radiation at UV wavelengths. It is believed that various flowers exhibit iridescence and reflect light in the UV range which enables bees to target nectar and pollen sources with a relatively high degree of accuracy. Bees are also believed to utilize polarized light patterns to further aid in navigation. For example, polarized light existing naturally may facilitate bees’ azimuthal orientation and improve directional navigation.

A first light source 314, which may include one or more lamps, is disposed adjacent to the grow line 102. For example, the first light source 314 is disposed laterally outward of the travel path 340 of the grow towers 150 to prevent or reduce the probability of the grow line 102 from blocking light travelling into the volume 322. In one example, the first light source 314 includes a plurality of lamps extending substantially parallel to one another on opposing lateral sides of the grow line 102. In one embodiment, the first light source 314 is disposed above the grow line 102. In another embodiment, the first light source 314 is coupled to the grow line 102. In another embodiment, the first light source 314 is disposed below the grow line 102 but laterally adjacent to and out of a travel path 340 of the grow towers 150. In one embodiment, the first light source 314 extends a length of the volume 322 from approximately the first air curtain 302 to the second air curtain 304. Alternatively, the first light source 314 extends a distance less than a length of the volume 322 between the air curtains 302, 304. A filter, such as a polarization filter or other filter configured to modify characteristics of light emitted from the first light source 314, may be disposed over the first light source 314 to modulate characteristics of the light propagating into the volume 322.

A second light source 318, which may include one or more lamps, is disposed adjacent to the floor 326 and opposite the first light source 314. For example, the second light source 318 is disposed laterally outward of the travel path 340 of the grow towers 150 to prevent or reduce the probability of the grow towers 150 from blocking light travelling into the volume 322 toward the plants 324. In one example, the second light source 318 includes a plurality of lamps extending substantially parallel to one another on opposing lateral sides of the travel path 340 occupied by the grow towers 150. The second light source 318 extends a length of the volume 322 from approximately the first air curtain 304 to the second air curtain 304. Alternatively, the second light source 318 extends a distance less than a length of the volume 322 between the air curtains 302, 304. Similar to the first light source 314, the second light source 318 may include a polarization filter or other filter configured to modify characteristics of light emitted from the second light source 318.

The first and second light source 314, 318 oppose one another and reduce the probability of unilluminated or dark regions on the grow tower 150. Because plants 324 are distributed along a length of the grow towers 150 in a vertical orientation, the lights sources 314, 318 are positioned and arranged to illuminate substantially the entire length of the grow towers 150.

In one embodiment, a third light source 330 is disposed within the volume 322 but laterally outward of the travel path 340 of the grow towers 150. In this embodiment, the third light source 330 is disposed adjacent to the first air curtain 302. In another embodiment, the third light source 330 is disposed outside of the volume 322 adjacent to the first air curtain 302 but laterally outward of the travel path 340. In this embodiment, light emitted by the third light source 330 travels through the first air curtain 302 without substantial disruption as the first air curtain 302 does not exhibit a substantially different refractive index from the air environment within the volume 322. The third light source 330, which may include one or more lamps, extends a length vertically similar to a length of the grow towers 150. In alternative embodiments, the vertically extending length of the third light source 330 may be greater than or less than the length of the grow towers 150.

In one embodiment, a fourth light source 334 is disposed within the volume 322 but laterally outward of the travel path 340 of the grow towers 150. In this embodiment, the fourth light source 334 is disposed adjacent to the second air curtain 304. In another embodiment, the fourth light source 334 is disposed outside of the volume 322 adjacent to the second air curtain 304 but laterally outward of the travel path 340. In this embodiment, light emitted by the fourth light source 330 travels through the second air curtain 304 without substantial disruption as the second air curtain 304 does not exhibit a substantially different refractive index from the air environment within the volume 322. The fourth light source 334, which may include one or more lamps, extends a length vertically similar to a length of the grow towers 150. In alternative embodiments, the vertically extending length of the fourth light source 334 may be greater than or less than the length of the grow towers 150.

In embodiments utilizing the light sources 330, 334, the light sources 330, 334 are disposed on opposite sides of the travel path 340. Thus, the grow towers 150 travel freely between the light sources 330, 334 and front and back sides of the grow towers 150 are exposed to illumination. Similar to the light sources 314, 318, the light sources 330, 334 may include polarizing filters or other filters configured to modify characteristics of light emitted from the light sources 330, 334.

In operation, the light sources 330, 334 are utilized to illuminate plants 324 in the grow towers 150, but are also utilized to influence bee movement within the volume 322. For example, when grow towers 150 are moved into the volume 322, the grow towers 150 will traverse through the first air curtain 302 or the first air curtain 302 will be temporarily turned off to enable passage of the grow tower 150 therethrough without damage to the plants 324. To prevent or substantially reduce the probability of the bees 328 from escaping from the volume 322, the fourth light source 334 is activated to attract the bees 328 away from a region of the volume 322 adjacent to the first air curtain 302. In this embodiment, the third light source 330 remains unilluminated during entry of the grow towers 150 into the volume 322. It is contemplated that the light sources 314, 318 may also be utilized to modulate bee navigation away from the first air curtain 302.

Similarly, when the grow towers 150 are moved out of the volume 322 through the second air curtain 304, the fourth light source 334 is unilluminated and the third light source 330 is illuminate to encourage been navigation away from a region of the volume 322 adjacent the second air curtain 304. It is contemplated that the light source 314, 318 may also be utilized to modulate bee navigation away from the second air curtain 304.

While four light sources 314, 318, 330, 334 are illustrated and may be utilized together simultaneously, various combinations of light sources may be utilized to illuminate the plants 324. It is contemplated that one, two, or three of the light sources 314, 318, 330, 334 can be utilized in any combination. For example, the light sources 314, 318 may be utilized for illumination and the light sources 330, 334 may not be utilized. Alternatively, the light sources 330, 334 may be utilized for illumination and the light sources 314, 318 may not be utilized. In other embodiments, the light sources 314, 330 may be utilized for illumination while the light sources 318, 334 may not be utilized, and vice versa. In other embodiments, the light sources 318, 330 are utilized for illumination while the light sources 314, 334 are not utilized.

The first light source 314 is in electrical communication with a first power source 316, the second light source 318 is in electrical communication with a second power source 320, the third light source 330 is in electrical communication with a third power source 332, and the fourth light source 334 is in electrical communication with a fourth power source 336. The power sources 316, 320, 332, 336 may be the same power source or different power sources and may be individually controllable.

Each of the power sources 316, 320, 332, 336 are in communication with a controller 350. The power sources 316, 320, 332, 336, and thus the light sources 314, 318, 330, 334, are controlled by the controller 350 that is generally designed to facilitate the control and automation of the light sources 314, 318, 330, 334 within the system 300. The controller 350 includes, but is not limited to, a central processing unit (CPU), memory, and support circuits. The CPU may be one of any form of computer processor used in industrial settings for controlling various system functions, such as activation and deactivation of the light sources 314, 318, 330, 334, and other coordination and control of system processes. The memory is connected to the CPU, and may be one or more of a readily available memory, such as random access memory (RAM), read only memory (ROM), floppy disk, hard disk, solid state, flash memory, magnetic memory, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the controller 350 determines operation of the light sources 314, 318, 330, 334. The program is software readable by the controller 350 that includes code to perform tasks relating to activation, deactivation, monitoring, and coordination of the light sources 314, 318, 330, 334 with other aspects of the system 300, such as coordination with the controller 360 for operation of the air curtains 302, 304 and movement of the grow towers 150 along the grow line 102. For example, the controller 350 includes program code that synchronizes activation and deactivation of the light sources 314, 318, 330, 334 to coordinate bee movement within the volume 322 during activation and deactivation of the air curtains 302, 304 and lighting of the plants 324 to facilitate efficient bee movement within the volume 322 for pollination of the plants 324.

FIG. 3B is a schematic side view of a pollination system 390 of the controlled environment agriculture system 100 according to an embodiment of the disclosure. The system 390 is implemented within the tower conveyance system 110 or in a different region of the system 100. In one example, the system 390 is implemented at a location within the tower conveyance system 110 between the load transfer conveyance system 104 and the unload transfer conveyance system 106. In another example, the system 390 is implemented in a region of the system 100 which is adjacent to or adjoining the tower conveyance system 110.

The system 390 is integrated with the grow lines 102 and the grow towers 150. The system 390 includes a plurality of air curtains, first, second, and third walls 402, 404, 406, respectively (illustrated in FIGS. 4 and 5), and light sources 314, 318, 330, 334 (illustrated in FIG. 3A). The air curtains, walls 402, 404, 406, and floor 326 define a volume 322 within which pollination is performed by pollination vectors, such as bees 328. While bees 328 are illustrated and described as the pollination vectors herein, it is contemplated that other pollinators may be utilized in accordance with the embodiments described herein. Other pollinators include, but are not limited to, butterflies, beetles, flies, wasps, moths, and other flying insects capable of performing pollination.

The system 390 includes a fourth wall 382 and a fifth wall 384. In one embodiment, the walls 382, 384 are disposed perpendicular to the walls 402, 404. It is contemplated that other arrangements of the walls 382, 384, 402, 404 may be utilized to define the volume 322. An opening 374 is formed in the fourth wall 382. The opening 374 is sized to provide for passage of the grow line 102 and grow towers 150 therethrough. In one embodiment, the opening 374 is aligned along the travel path 340. An opening 376 is formed in the fifth wall 384 substantially opposite the opening 374. Similar to the opening 374, the opening 376 is sized to provide for passage of the grow line 102 and grow towers 150 therethrough along the travel path 340.

A first plurality of nozzles 366 and a second plurality of nozzles 388 are disposed adjacent to the opening 374. In one embodiment, the first plurality of nozzles 366 are disposed on a first side of the opening 374 and the second plurality of nozzles 388 are disposed on a second side of the opening 374 opposite the first side of the opening 374. For example, the nozzles 366, 388 are disposed on opposing sides of the travel path 340. In one embodiment, the first plurality of nozzles 366 and the second plurality of nozzles 388 are aligned substantially parallel with one another. The nozzles 366, 388 are coupled to the fourth wall 382 in one embodiment. Alternatively, the nozzles 366, 288 may be coupled to another structure member or members which are disposed on opposite sides of the travel path 340. In one embodiment, the nozzles 366, 388 extend vertically a magnitude which is greater than a length of the grow towers 150.

A third plurality of nozzles 370 and a fourth plurality of nozzles 372 are disposed adjacent to the opening 376. In one embodiment, the third plurality of nozzles 370 are disposed on a first side of the opening 376 and the fourth plurality of nozzles 372 are disposed on a second side of the opening 376 opposite the first side of the opening 376. For example, the nozzles 370, 372 are disposed on opposing sides of the travel path 340. In one embodiment, the third plurality of nozzles 370 and the fourth plurality of nozzles 372 are aligned substantially parallel with one another. The nozzles 370, 372 are coupled to the fifth wall 384 in one embodiment. Alternatively, the nozzles 370, 372 may be coupled to another structure member or members which are disposed on opposite sides of the travel path 340. In one embodiment, the nozzles 370, 372 extend vertically a magnitude which is greater than a length of the grow towers 150.

The nozzles 366, 388 are positioned and oriented to generate a fluid flow adjacent to the volume 322. For example, the nozzles 366, 388 are positioned such that the nozzles 366, 388 face one another at 180° to generate an air curtain across the opening 374. In other embodiments, the nozzles 366, 388 face one another at different angles which generate air curtains either within the volume 322 or upstream of the opening 374 along the travel path 340. Similarly, the nozzles 370, 372 are positioned and oriented to generate a fluid flow adjacent to the volume 322. For example, the nozzles 370, 372 are positioned such that the nozzles 370, 372 face one another at 180° to generate an air curtain across the opening 374. In other embodiment, the nozzles 370, 372 face one another at different angles which generate air curtains either within the volume 322 or downstream of the opening 376 along the travel path 340.

In operation, each of the nozzles 366, 388, 370, 372 is in fluid communication with a fluid source, such as a gas or air source. In one embodiment, fluid is pressurized and delivered through the nozzles 366, 388, 370, 372 at a flow rate sufficient to generate an air curtain which is sufficient to retain the bees 328 with the volume 322. One or more exhaust modules 378, 380 are in fluid communication with the volume 322. The exhaust modules 378, 380 include fans, pumps, or other suitable apparatus to evacuate fluid from the volume 322. In one embodiment, fluid evacuated from the volume 322 is recirculated within the system 390 by delivering the evacuated fluid through one or more of the nozzles 366, 388, 370, 372 into the volume 322.

Each of the nozzles 366, 388, 370, 372 and exhaust modules 378, 380 are in communication with the controller 360. Similar to the system 300 of FIG. 3A, the controller 360 is utilized to control operation of the system 390. For example, moving a grow tower 150 into and out of the volume 322 is enabled by implementing the controller 360 to control generation of air curtains to retain the bees 328 within the volume 322. The controller 360 provides a signal stopping flow of fluid through the nozzles 366, 388 and signals the grow tower 150 to move along the grow line 102 through the opening 374 into the volume 322. The controller 360 then provides a signal reestablishing fluid flow through the nozzles 366, 388 to generate an air curtain occluding the opening 374.

After a sufficient amount of time has elapsed to enable pollination of plants in the grow tower 150 by the bees 328, the controller 360 provides a signal stopping flow of fluid through the nozzles 370, 372 and the grow tower 150 is moved along the grow line 102 out of the volume 322 through the opening 376. The controller 360 then provides a signal reestablishing fluid flow through the nozzles 370, 372 to reestablish an air curtain occluding the opening 376. The controller 360 also controls operation of the exhaust modules 378, 380, which are operated in a continuous exhausting mode or an intermittent exhausting mode, depending upon the desired fluid turnover within the volume 322.

In one embodiment, the system 390 also includes various lighting or illumination apparatus elements from the system 300 illustrated in FIGS. 4 and 5. In this manner, the bees 328 may be further controlled or influenced to facilitate pollination as described with regard to FIGS. 4 and 5.

FIG. 4 is a schematic end view of the pollination system 300 of either FIGS. 3A or 3B according to an embodiment of the disclosure. The illustrated embodiment is viewed coaxially along the travel path 340 such that the grow towers 150, when moved, travel into and out of the page. As described with regard to FIGS. 3A or 3B, walls 402, 404, 406 define the volume 322 in combination with the air curtains 302, 304 and the floor 326. While the floor 326 may be the floor of a facility, the floor 326 is not limited to a floor but may be considered as a base or bottom wall which defines at least one side of the volume 322. A first wall 402 and a second wall 404 are disposed opposite one another. The walls 402, 404 are disposed laterally outward of the travel path 340 of the grow towers 150 and laterally outward of the grow line 102. A third wall 406 extends between the walls 402, 404 and forms a ceiling or top member of the volume 322. The third wall 406 accommodates passage of the grow line 102 therethrough via an opening 416 formed in the third wall 406. The opening 416 is sized to fit around a portion of the grow line 102 but prevent the escape of the bees 328 from the volume 322.

The first wall 402 and the second wall 404 extend in a direction parallel to the travel path 340. In one embodiment, the first wall 402 and the second wall 404 are parallel to one another. The walls 402, 404 extend along the travel path 340 from the first air curtain 302 to the second curtain 304. Similarly, the third wall 406 extends from the first air curtain 302 to the second air curtain 304. The walls 402, 404, 406 may be fabricated from any material suitable for preventing the bees 328 from escaping from the volume 322. In one embodiment, the walls 402, 404, 406 are fabricated from a polymeric material. The polymeric material may be selected to have a desired opacity to further modulate characteristics of light within the volume 322. In one example, the polymeric material is substantially transparent to enable the passage of light therethrough. Alternatively, the polymeric material is fabricated with a desired degree of opacity to prevent light from outside of the volume 322 from reaching the plants 324. The material itself may be semi or fully opaque or a film with a desired degree of opacity may be adhered to the material. Various patters of opaque and transparent material, or even reflective material, may also be utilized to modulate light characteristics and enhance control of bee navigation within the volume 322. In other embodiments, the material selected for the walls 402, 404, 406 is a mesh or screen material.

In one embodiment, a fifth light source 408 is disposed on or adjacent to the first wall 402. In another embodiment, a sixth light source 410 is disposed on or adjacent to the second wall 404. The light sources 408, 410 may be a single lamp or multiple lamps spaced apart along the travel path 340 from the first air curtain 302 to the second air curtain 304. In embodiments, utilizing multiple lamps spaces along the travel path 340, the controller 350 may be utilized to control illumination of the lamps sequentially as the grow towers 150 traverse through the volume 322 along the travel path 340. Alternatively, the multiple lamps are illuminated together. In one embodiment, the light sources 408, 410 extend a major axis length similar to the length of the grow towers 150. In alternate embodiments, the major axis lengths of the light source 408, 410 may be greater than or less than the length of the grow towers 150.

The fifth light source 408 is in electrical communication with a fifth power source 412. The sixth light source 410 is in electrical communication with a sixth power source 414. The power sources 412, 414 may be the same power source of different power sources, such as the power sources 316, 320, 332, 336. Similar to the light sources 314, 318, 330, 334 and corresponding power sources 316, 320, 332, 336, the power sources 412, 414 are in communication with the controller 350. Accordingly, the controller 350 controls operation of the light sources 408, 410.

FIG. 5 is a schematic end view of the pollination system 300 of Figure according to an embodiment of the disclosure. The illustrated embodiment in FIG. 5 is viewed from the same perspective as the illustration of FIG. 4. The embodiment illustrate in FIG. 5 replaces the first light source 314 with upper light sources 502, 504 and replaces the second light source 318 with lower light sources 506, 508. The upper light sources 502, 504 are positioned at non-normal angles to a major axis of the grow towers 150. A first upper light source 502 is positioned within the volume 322 on a first side of the grow line 102 and a second upper light source 504 is positioned within the volume 322 on a second side of the grow line 102 opposite the first upper light source 502. In one embodiment, the first upper light source 502 is coupled between the wall 402 and the wall 406 and the second upper light source 504 is coupled between the wall 404 and the wall 406. The light sources 502, 504 may be similar to the first light source 314 and may be a singular lamp or a plurality of lamps. The light sources 502, 504 are coupled to a seventh power source 510.

In one embodiment, the light sources 502, 504 include focusing elements 514 which direct light emitted from the light source 502, 504 to specific regions of the grow towers 150. The focusing elements 514 are reflectors, lenses, or the like and may be utilized to increase the intensity, focus, or otherwise direct the light emitted by the light sources 502, 504. Due to the angled positioning of the light sources 502, 504 relative to the grow towers 150 and the utilization of the focusing elements 514, light from the light sources 502, 504 is concentrated on a first portion 516 of the grow towers 150. The concentration of light is believed to increase the amount of UV electromagnetic energy present near the plants 324 to guide the bees 328 to the plants 324.

The lower light sources 506, 508 are positioned at non-normal angles to a major axis of the grow towers 150. A first lower light source 506 is positioned within the volume 322 on a first side of the grow line 102 and a second lower light source 508 is positioned within the volume 322 on a second side of the grow line 102 opposite the first lower light source 506. In one embodiment, the first lower light source 506 is coupled between the wall 402 and the floor 326 and the second lower light source 506 is coupled between the wall 404 and the floor 326. The light sources 506, 508 may be similar to the second light source 318 and may be a singular lamp or a plurality of lamps. The light sources 506, 508 are coupled to an eighth power source 512.

In one embodiment, the light sources 506, 508 include the focusing elements 514 which direct light emitted from the light source 502, 504 to specific regions of the grow towers 150. Due to the angled positioning of the light sources 506, 508 relative to the grow towers 150 and the utilization of the focusing elements 514, light from the light sources 506, 508 is concentrated on a second portion 518 of the grow towers 150. The concentration of light is believed to increase the amount of UV electromagnetic energy present near the plants 324 to guide the bees 328 to the plants 324.

The upper light sources 502, 504 illuminate the region 516 and the lower light sources 506, 508 illuminate the region 518 such that an entire length 520 of the grow towers 150 is illuminated. The light sources 502, 504, 506, 508 may be utilized alone or in combination with the other light sources 314, 318, 330, 334, 408, 410 described herein. Such light source coordination is enabled by the controller 350 which is also in electrical communication with the power sources 510, 512. While the light sources 502, 504, 506, 508 are illustrated employing the focusing elements 514, it is contemplated that the other light sources 314, 318, 330, 334, 408, 410 may also utilize the focusing elements 514 to improve lighting characteristics within the volume 322 to improve bee navigation and pollination efficiency.

The system 300 depicted in FIGS. 3, 4, and 5 illustrates a single grow tower 150 in the volume 322 during pollination. However, it is contemplated that multiple grow towers 150 may be disposed within the volume 322 concurrently. In one embodiment, the grow towers 150 are moved into the volume 322 and are maintained in a stationary position during pollination. In another embodiment, the grow towers 150 are moved into the volume 322 and continuously move through the volume 322 during pollination.

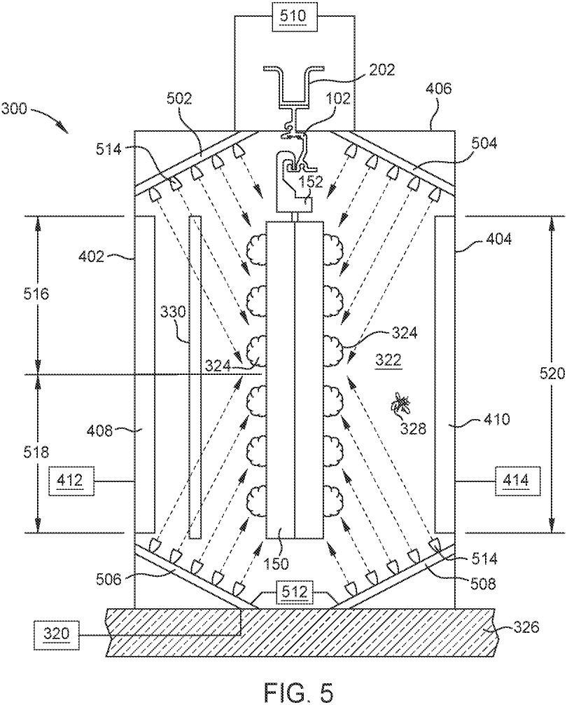

FIG. 6 is a schematic side view of a pollination system 600 of the controlled environment agriculture system 100 according to an embodiment of the disclosure. The system 600 includes a plurality of first light sources 602a, 604a, 606a, 608a, 610a, 612a and a plurality of second light sources 602b, 604b, 606b, 608b, 610b, 612b disposed opposite the first light sources 602a, 604a, 606a, 608a, 610a, 612a. Although six pairs of light sources are illustrated, it is contemplated that a greater or lesser number of light sources may be utilized.

The first light sources 602a, 604a, 606a, 608a, 610a, 612a are disposed above the grow towers 150. In one embodiment, the first light sources 602a, 604a, 606a, 608a, 610a, 612a are coupled to the grow line 102. Each light source of the first light sources 602a, 604a, 606a, 608a, 610a, 612a are spaced from one another along the travel path 340 of the grow towers 150. In one embodiment, the spacing between adjacent light sources is sized to accommodate positioning of a grow tower 150 beneath each light source of the light sources 602a, 604a, 606a, 608a, 610a, 612a. In one embodiment, the spacing between adjacent light sources is substantially equal. Alternatively, spacing between adjacent light sources is unequal and light source concentration may differ along the travel path 340.

The second light sources 602b, 604b, 606b, 608b, 610b, 612b are disposed below the grow towers 150. In one embodiment, the second light sources 602b, 604b, 606b, 608b, 610b, 612b are coupled to the floor 326 or other base or structural member. Each light source of the second light sources 602b, 604b, 606b, 608b, 610b, 612b are spaced from one another along the travel path 340 of the grow towers 150. In one embodiment, the spacing between adjacent light sources is sized to accommodate positioning of a grow tower 150 above each light source of the light sources 602b, 604b, 606b, 608b, 610b, 612b. In one embodiment, the spacing between adjacent light sources is substantially equal. Alternatively, spacing between adjacent light sources is unequal and light source concentration may differ along the travel path 340.

In one embodiment, a first pair of light sources 602a, 602b are substantially vertically aligned. In another embodiment, a second pair of light sources 604a, 604b are substantially vertically aligned. In another embodiment, a third pair of light sources 606a, 606b are substantially vertically aligned. In another embodiment, a fourth pair of light sources 608a, 608b are substantially vertically aligned. In another embodiment, a fifth pair of light sources 610a, 610b are substantially vertically aligned. In another embodiment, a sixth pair of light sources 612a, 612b are substantially vertically aligned.

Each of the first light sources 602a, 604a, 606a, 608a, 610a, 612a are in electrical communication with a first power source 614. Each of the second light sources 602b, 604b, 606b, 608b, 610b, 612b are in electrical communication with a second power source 616. The power sources 614, 616 are in communication with the controller 350 which facilitates coordinated operation of the respective light sources.

In one example, the controller 350 activates the first pair of light sources 602a, 602b while the remaining pairs of light sources remain unilluminated. Because the grow tower 150 between the first pair of light sources 602a, 602b is illuminated, the bees are likely to be attracted and pollinate the pants 324 in that grow tower 150. After an amount of time sufficient to ensure pollination, the first pair of light sources 602a, 602b are deactivated and other pairs of light sources may be illuminated to encourage bee navigation and pollination of the plants 324. Various pairs of light sources may be activated and deactivated in any desired pattern. A single pair of light sources may be activated at one time or several pairs may be activated at a single time.

It is contemplated that any combination of light source pairs may be activated and deactivated depending upon the desired bee navigation and pollination timing profile. In one embodiment, the light source illumination is not limited to pairs of light sources. For example, each of the light sources 602a, 604a, 606a, 608a, 610a, 612a are illuminated while the light sources 602b, 604b, 606b, 608b, 610b, 612b are deactivated to encourage pollination of plants disposed in an upper region of the grow towers 150. Alternatively, each of the light sources 602b, 604b, 606b, 608b, 610b, 612b are illuminated while the light sources 602a, 604a, 606a, 608a, 610a, 612a are deactivated to encourage pollination of plants disposed in a lower region of the grow towers 150. Pairs of light sources may also be coordinated with opening and closing of the air curtains 302, 304 to move bees away from the air curtains when grow towers 150 are passing through the air curtains 302, 304.

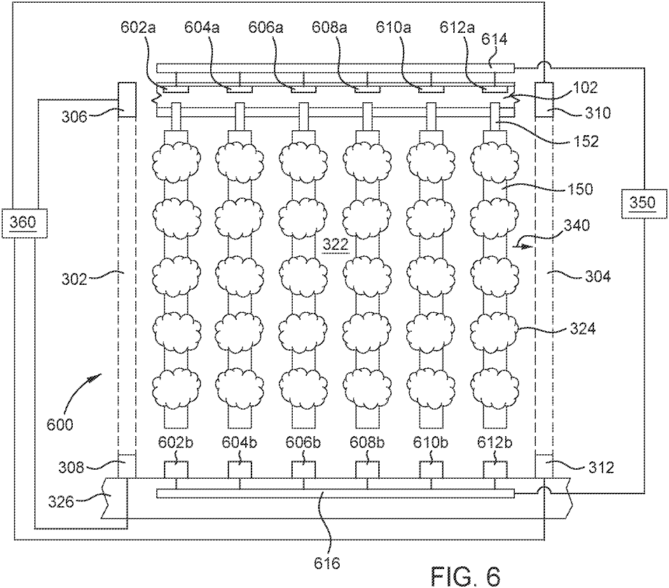

FIG. 7 is a block diagram illustrating operations of a pollinator control method 700 according to an embodiment of the disclosure. At operation 710 pollinators, such as bees, are positioned in a pollination chamber, such as the volume 322 of the systems 300, 600. At operation 720, air curtains are activated. The air curtains, such as air curtains 302, 304, in combination with other enclosure structures, such as walls 402, 404, 406, enclose the pollination chamber and prevent escape of the bees from the pollination chamber.

At operation 730, a grow tower, such as the grow towers 150, is moved through the first air curtain into the pollination chamber. In this embodiment, the air curtain may be active during movement of the grow tower through the air curtain. Once the grow tower is in the pollination chamber, various light modulation techniques as described herein may be utilized to encourage pollination of plants on the grow tower from the bees present within the pollination chamber. At operation 740, the grow tower is moved through a second air curtain out of the pollination chamber. In this embodiment, the second air curtain is active during movement of the grow tower through the air curtain. When the grow towers are in the pollination chamber, the grow towers may be maintained in a stationary position or may be moved continuously through the pollination chamber. The method 700 is repeated for subsequent grow towers.

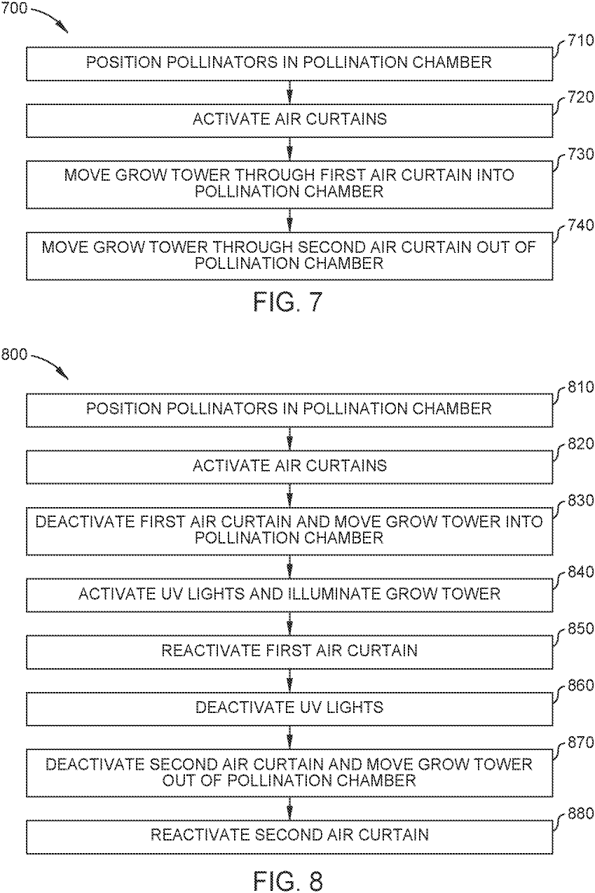

FIG. 8 is a block diagram illustrating operations of a pollinator control method 800 according to an embodiment of the disclosure. At operation 810, pollinators, such as bees, are positioned in a pollination chamber, such as the volume 322 of the systems 300, 390, 600. At operation 820, air curtains, such as the air curtains 302, 304, are activated. The air curtains in combination with other enclosure structures, such as walls 402, 404, 406, enclose the pollination chamber and prevent escape of the bees from the pollination chamber.

At operation 830, a first air curtain, such as the air curtain 302, is deactivated and a grow tower, such as the grow towers 150, is moved into the pollination chamber. At operation 840, UV lights are activated and the grow towers is illuminated. At operation 850, the first air curtain is reactivated. In one embodiment, the UV lights are activated prior to reactivation of the first air curtain. In another embodiment, the first air curtain is reactivated prior to activation of the UV lights. The UV lights remain activated for a duration sufficient to ensure pollination of the plants by the pollinators.

At operation 860, the UV lights are deactivated. At operation 870, a second air curtain, such as the air curtain 304, is deactivated and the grow tower is moved out of the pollination chamber. In one embodiment, the UV lights are deactivated prior to deactivation of the second air curtain. In another embodiment, the second air curtain is deactivated prior to deactivation of the UV lights. At operation 880, the second air curtain is reactivated to keep the pollinators within the chamber. When the grow towers are in the pollination chamber, the grow towers may be maintained in a stationary position or may be moved continuously through the pollination chamber. Similar to the method 700, the method 800 is repeated for subsequent grow towers.

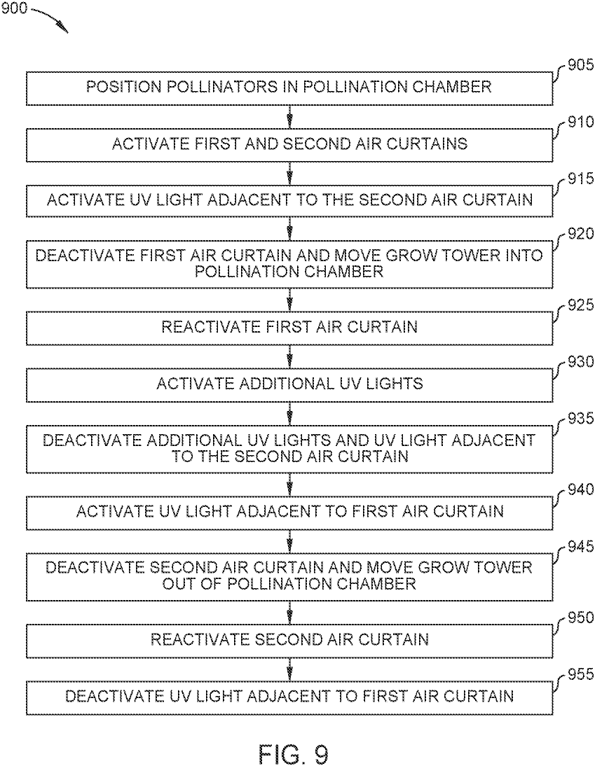

FIG. 9 is a block diagram illustrating operations of a pollinator control method 900 according to an embodiment of the disclosure. At operation 905, pollinators, such as bees, are positioned in a pollination chamber, such as the volume 322 of the systems 300, 390, 600. At operation 910, first and second air curtains, such as the air curtains 302, 304, are activated. The air curtains in combination with other enclosure structures, such as walls 402, 404, 406, enclose the pollination chamber and prevent escape of the bees from the pollination chamber.

At operation 915, a UV light, such as light source 334 or light sources 612a, 612b, adjacent to the second air curtain is activated. At operation 920, the first air curtain is deactivated and a grow tower, such as the grow towers 150, is moved into the pollination chamber. At operation 925, the first air curtain is reactivated. At operation 930, additional UV lights are activated. Examples of additional UV lights include, but are not limited to light sources 314, 318, 330, 408, 410, 502, 504, 506, 508, 602a/602b, 604a/604b, 606a/606b, 608a/608b, 610a/610b. At operation 935, the additional UV lights and the UV light adjacent to the second air curtain are deactivated.

At operation 940, a UV light, such as the light source 330 or light sources 602a, 602b, adjacent to the first air curtain is activated. At operation 945, the second air curtain is deactivated and the grow tower is moved out of the pollination chamber. At operation 950, the second air curtain is reactivated. At operation 955, the UV light adjacent to the first air curtain is deactivated. When the grow towers are in the pollination chamber, the grow towers may be maintained in a stationary position or may be moved continuously through the pollination chamber. Similar to the methods 700, 800, the method 900 is repeated for subsequent grow towers.

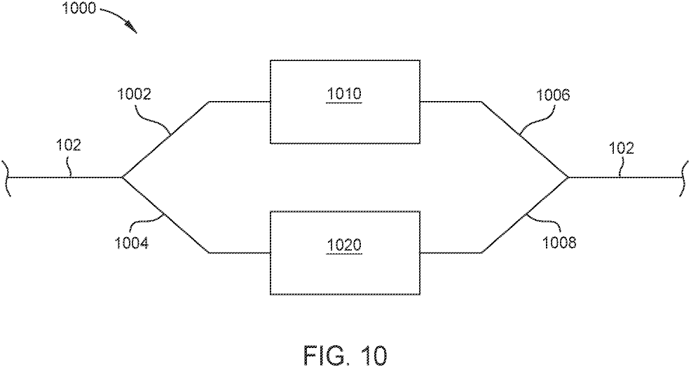

FIG. 10 illustrates a schematic plan view of a pollination system 1000 according to an embodiment described herein. In one embodiment, the system 1000 is implemented within or adjacent to the system 100. For example, the system 1000 is implemented within the conveyance system 110 or adjacent to the conveyance system 110.

The system 1000 includes one or more pollination stations 1010, 1020, for example, two pollination stations. The pollination stations 1010, 1020, are any of the systems 300, 390, 600. In one embodiment, a first pollination station 1010 is either the system 300 or the system 390 and a second pollination station 1020 is the system 600. However, any system configuration may be utilized for the pollination stations 1010, 1020.

The grow line 102 splits to a first track 1002 and a second track 1004. The first track 1002 is configured to convey grow towers 150 from the grow line 102 to the first pollination station 1010. Similarly, the second track 1004 is configured to convey grow towers 150 from the grow line 102 to the second pollination station 1020. After the plants in the grow towers 150 have been pollinated within the first pollination station 1010, the grow towers 150 are conveyed along a third track 1006 which extends between the first pollination station 1010 and the grow line 102 downstream of the first pollination station 1010. Similarly, after the plants in the grow towers 150 have been pollination within the second pollination station 1020, the grow towers 150 are conveyed along a fourth track 1008 which extends between the second pollination station 1020 and the grow line 102 downstream of the second pollination station 1020. It is contemplated that each of the tracks 1002, 1004, 1006, 1008 are configured similarly to the grow line 102 as described with regard to FIG. 2.

While two pollination stations 1010, 1020 and respective tracks 1002, 1006, 1004, 1008 are illustrated, it is contemplated three, four, five, or more pollination stations and the associated tracks may be implemented to increase pollination throughput. In an operational embodiment, grow towers 150 are conveyed along the grow line 102 and the first track 1002 through the first pollination station 1010 and along the third track 1006 during a first time interval. During a second time interval, the grow towers 150 are conveyed along the grow line 102 and the second track 1004 through the second pollination station 1020 and along the fourth track 1008. In one embodiment, the first time interval and second time interval are 12 hour shifts. For example, the first pollination station 1010 and associated tracks 1002, 1006 are utilized from 12 AM to 12 PM and the second pollination station 1020 and associated tracks 1004, 1008 are utilized from 12 PM to 12 AM. As such, the bees 328 are allowed to rest in the pollination station which is out of service. It is also contemplated that the pollination station which is out of service may be subject to maintenance during that time or the bee population may be exchanged or otherwise cared for.

In another embodiment, the pollination stations 1010, 1020 are utilized concurrently. In this embodiment, a first grow tower 150 is directed to the first pollination station 1010 along the associated tracks 1002, 1004 and a second grow tower 150 is directed to the second pollination station 1020 along the associated tracks 1004, 1008. This process is repeated for each subsequent grow tower 150 which is conveyed along the grow line 102. Advantageously, higher throughput utilizing multiple pollination stations is enabled when compared to a utilization of a single pollination station. Alternatively, throughput may remain similar to utilization of a single pollination station, but residence time of the grow tower 150 within the pollination station is increased. Such increase of residence time increases the probability of more completed plant pollination in the multiple pollination station implementation as compared to single pollination station embodiments.

Exemplary implementations of the disclosure are described herein and may be combined with one another without further recitation.

In one implementation, a pollination system includes a grow line having a plurality of grow towers disposed thereon and a pollination chamber. The pollination chamber includes a plurality of walls at least partially defining a volume, a first flow generator positioned adjacent to the plurality of walls, and a second flow generator positioned adjacent to the plurality of walls and opposite the first flow generator. A plurality of light sources are disposed within the pollination chamber.

The system according to any one of the previous implementations and further comprising a first flow receiver disposed opposite the first flow generator and a second flow receiver disposed opposite the second flow generator.

The system according to any one of the previous implementations wherein the first flow generator and the second flow generator are configured to generate first and second air curtains, respectively.

The system according to any one of the previous implementations wherein the plurality of light sources are ultraviolet light sources.

The system according to any one of the previous implementations wherein the ultraviolet light sources are light emitting diodes.

The system according to any one of the previous implementations wherein the ultraviolet light sources comprise a polarization filter.

The system according to any one of the previous implementations wherein the ultraviolet light sources comprise a lens or reflector.

The system according to any one of the previous implementations wherein a first light source of the plurality of light sources is disposed above the grow towers.

The system according to any one of the previous implementations wherein a second light source of the plurality of light sources is disposed below the grow towers.

The system according to any one of the previous implementations wherein a third light source of the plurality of light sources is disposed adjacent to the first flow generator.

The system according to any one of the previous implementations wherein a fourth light source of the plurality of light sources is disposed adjacent to the second flow generator.

The system according to any one of the previous implementations wherein the third light source and the fourth light source are disposed on opposite sides of a travel path of the grow towers.

The system according to any one of the previous implementations wherein a fifth light source of the plurality of light sources is disposed adjacent to a first wall of the plurality of walls.

The system according to any one of the previous implementations wherein a sixth light source of the plurality of light sources is disposed adjacent to a second wall of the plurality of walls opposite the first wall.

The system according to any one of the previous implementations wherein the plurality of walls comprise an opaque material.

The system according to any one of the previous implementations wherein each grow tower of the plurality of grow towers is coupled to the grow line by a hook.

In one implementation, a pollination system includes a plurality of walls, a first flow generator disposed adjacent to the plurality of walls and configured to generate a first air curtain, and a second flow generator disposed adjacent to the plurality of walls and configured to generate a second air curtain, the second air curtain disposed opposite the first air curtain, wherein the plurality of walls, the first air curtain, and the second air curtain define a volume. A plurality of light sources are disposed in the volume.

The system according to any one of the previous implementations wherein the plurality of light sources are ultraviolet light sources.

The system according to any one of the previous implementations wherein the ultraviolet light sources are light emitting diodes.

The system according to any one of the previous implementations wherein the ultraviolet light sources comprise a polarization filter.

The system according to any one of the previous implementations wherein the ultraviolet light sources comprise a lens or reflector.

The system according to any one of the previous implementations wherein a first light source of the plurality of light sources is disposed above the grow towers.

The system according to any one of the previous implementations wherein a second light source of the plurality of light sources is disposed below the grow towers.

The system according to any one of the previous implementations wherein a third light source of the plurality of light sources is disposed adjacent to the first flow generator.

The system according to any one of the previous implementations wherein a fourth light source of the plurality of light sources is disposed adjacent to the second flow generator.

The system according to any one of the previous implementations wherein the third light source and the fourth light source are disposed on opposite sides of a travel path of the grow towers.

The system according to any one of the previous implementations wherein a fifth light source of the plurality of light sources is disposed adjacent to a first wall of the plurality of walls.

The system according to any one of the previous implementations wherein a sixth light source of the plurality of light sources is disposed adjacent to a second wall of the plurality of walls opposite the first wall.

The system according to any one of the previous implementations wherein the plurality of walls comprise an opaque material.

In one implementation, a pollination system includes a grow line having a plurality of grow towers disposed thereon and a pollination chamber. The pollination chamber includes a plurality of walls at least partially defining a volume, a first flow generator positioned adjacent to the plurality of walls, and a second flow generator positioned adjacent to the plurality of walls and opposite the first flow generator. A plurality of light sources are disposed within the pollination chamber. The plurality of light sources include a plurality of light source pairs, wherein a first light source of a pair is disposed above the grow towers and a second light source of the pair is disposed below the grow towers, and wherein the plurality of light source pairs are positioned within the volume along a travel path of the grow towers.

The system according to any one of the previous implementations further comprising a first flow receiver disposed opposite the first flow generator and a second flow receiver disposed opposite the second flow generator.

The system according to any one of the previous implementations wherein the first flow generator and the second flow generator are configured to generate first and second air curtains, respectively.

The system according to any one of the previous implementations wherein the plurality of light source pairs are ultraviolet light sources.

The system according to any one of the previous implementations wherein the ultraviolet light sources are light emitting diodes.

The system according to any one of the previous implementations wherein the ultraviolet light sources comprise a polarization filter.

The system according to any one of the previous implementations wherein the ultraviolet light sources comprise a lens or reflector.

The system according to any one of the previous implementations wherein the plurality of walls comprise an opaque material.

The system according to any one of the previous implementations wherein each grow tower of the plurality of grow towers is coupled to the grow line by a hook.

The system according to any one of the previous implementations wherein the travel path of the grow tower extends linearly between a first air curtain generated by the first flow generator and a second air curtain generated by the second flow generator.

In one implementation, a plant pollination method includes positioning pollinators in a pollination chamber, activating a plurality of air curtains to enclose a volume of the pollination chamber, moving one or more grow towers through a first air curtain of the plurality of air curtains, illuminating the grow towers with ultraviolet light in the volume of the pollination chamber, and moving the grow towers through a second air curtain of the plurality of air curtains.

The method according to any one of the previous implementations wherein the pollinators comprise bees, butterflies, beetles, flies, wasps, moths, other flying insects capable of performing pollination, and combinations thereof.

The method according to any one of the previous implementations wherein the grow towers are maintained in a stationary position within the volume during pollination of plants disposed in the grow towers.

The method according to any one of the previous implementations wherein the grow towers are moved continuously through the volume during pollination of plants disposed in the grow towers.

The method according to any one of the previous implementations wherein the ultraviolet light is polarized.

The method according to any one of the previous implementations wherein the grow towers are coupled to a grow line and a major axis of the grow towers is oriented vertically.

The method according to any one of the previous implementations wherein the grow line extends through the volume of the pollination chamber.

In one implementation, a plant pollination method includes positioning pollinators in a pollination chamber, activating a plurality of air curtains to enclose a volume of the pollination chamber, deactivating a first air curtain of the plurality of air curtains, moving one or more grow towers into the pollination chamber, activating ultraviolet lights and illuminating the grow towers, reactivating the first air curtain, deactivating the ultraviolet lights, deactivating a second air curtain of the plurality of air curtains, moving the grow towers out of the pollination chamber, and reactivating the second air curtain.

The method according to any one of the previous implementations wherein the pollinators comprise bees, butterflies, beetles, flies, wasps, moths, other flying insects capable of performing pollination, and combinations thereof.

The method according to any one of the previous implementations wherein the one or more grow towers are maintained in a stationary position within the volume during pollination of plants disposed in the grow towers.

The method according to any one of the previous implementations wherein the grow towers are moved continuously through the volume during pollination of plants disposed in the grow towers.

The method according to any one of the previous implementations wherein the ultraviolet light is polarized.

The method according to any one of the previous implementations wherein the grow towers are coupled to a grow line and a major axis of the grow towers is oriented vertically.

The method according to any one of the previous implementations wherein the grow line extends through the volume of the pollination chamber.

In one implementation, a plant pollination method includes positioning pollinators in a pollination chamber, activating a first air curtain and a second air curtain to enclose a volume of the pollination chamber, activating a first ultraviolet light adjacent to the second air curtain, deactivating the first air curtain, moving one or more grow towers into the pollination chamber, reactivating the first air curtain, activating one or more additional ultraviolet lights, deactivating the one or more additional ultraviolet lights and the first ultraviolet light adjacent to the second air curtain, activating a second ultraviolet light adjacent to the first air curtain, deactivating the second air curtain, moving the grow towers out of the pollination chamber, and reactivating the second air curtain.

The method according to any one of the previous implementations further comprising reactivating the second ultraviolet light adjacent to the first air curtain.

The method according to any one of the previous implementations wherein the pollinators comprise bees, butterflies, beetles, flies, wasps, moths, other flying insects capable of performing pollination, and combinations thereof.

The method according to any one of the previous implementations wherein the grow towers are maintained in a stationary position within the volume during pollination of plants disposed in the grow towers.

The method according to any one of the previous implementations wherein the grow towers are moved continuously through the volume during pollination of plants disposed in the grow towers.

The method according to any one of the previous implementations wherein one or more of the first ultraviolet light, the second ultraviolet light, and the additional ultraviolet lights are polarized.

The method according to any one of the previous implementations wherein the grow towers are coupled to a grow line and a major axis of the grow towers is oriented vertically.

The method according to any one of the previous implementations wherein the grow line extends through the volume of the pollination chamber.

In one implementation, a pollination system includes a grow line having a plurality of grow towers disposed thereon, a first track extending form the grow line to a first pollination station, a second track extending from the grow line to a second pollination station, a third track extending from the first pollination station to the grow line, and a fourth track extending from the second pollination station to the grow line.

The system according to any one of the previous implementations wherein the first track is upstream of the first pollination station and the third track and downstream of the first pollination station.

The system according to any one of the previous implementations wherein the second track is upstream of the second pollination station and the fourth track is downstream of the second pollination station.

The system according to any one of the previous implementations wherein each of the first pollination station and the second pollination station comprise a plurality of walls at least partially defining a volume, a first flow generator positioned adjacent to the plurality of walls, a second flow generator positioned adjacent to the plurality of walls and opposite the first flow generator, and a plurality of light sources disposed within the pollination chamber.

The system according to any one of the previous implementations wherein each of the first pollination station and the second pollination station comprise a plurality of walls, a first flow generator disposed adjacent to the plurality of walls and configured to generate a first air curtain, a second flow generator disposed adjacent to the plurality of walls and configured to generate a second air curtain, the second air curtain disposed opposite the first air curtain, wherein the plurality of walls, the first air curtain, and the second air curtain define a volume, and a plurality of light sources disposed in the volume.

The system according to any one of the previous implementations wherein each of the first pollination station and the second pollination station comprise a plurality of walls at least partially defining a volume, a first flow generator positioned adjacent to the plurality of walls, a second flow generator positioned adjacent to the plurality of walls and opposite the first flow generator, and a plurality of light sources disposed within the pollination chamber. The plurality of light sources comprise a plurality of light source pairs, wherein a first light source of a pair is disposed above the grow towers and a second light source of the pair is disposed below the grow towers, and wherein the plurality of light source pairs are positioned within the volume along a travel path of the grow towers.

In summation, embodiments and examples described herein provide apparatus and methods for pollination of plants and control of pollinators within an indoor controlled agricultural environment. The apparatus of the disclosure provides a pollination chamber having enclosure and lighting apparatus which are utilized to facilitate pollinator movement within the chamber and to encourage efficient pollination of plants on grow towers within the chamber.

While the foregoing is directed to embodiments of the present disclosure, other and further embodiments of the disclosure may be devised without departing from the basic scope thereof, and the scope thereof is determined by the claims that follow.

What is claimed is:

1. A pollination system, comprising:
a grow line having a plurality of grow towers disposed thereon; and
a pollination chamber, comprising:
a plurality of walls at least partially defining a volume;
a first flow generator positioned adjacent to the plurality of walls;
a second flow generator positioned adjacent to the plurality of walls and opposite the first flow generator; and
a plurality of light sources disposed within the pollination chamber.

2. The system of claim 1, further comprising:
a first flow receiver disposed opposite the first flow generator; and
a second flow receiver disposed opposite the second flow generator.

3. The system of claim 1, wherein the first flow generator and the second flow generator are configured to generate first and second air curtains, respectively.

4. The system of claim 1, wherein the plurality of light sources are ultraviolet light sources.

5. The system of claim 4, wherein the ultraviolet light sources are light emitting diodes.

6. The system of claim 4, wherein the ultraviolet light sources comprise a polarization filter.

7. The system of claim 4, wherein the ultraviolet light sources comprise a lens or reflector.

8. The system of claim 1, wherein a first light source of the plurality of light sources is disposed above the grow towers.

9. The system of claim 1, wherein a second light source of the plurality of light sources is disposed below the grow towers.

10. The system of claim 1, wherein a third light source of the plurality of light sources is disposed adjacent to the first flow generator.

11. The system of claim 10, wherein a fourth light source of the plurality of light sources is disposed adjacent to the second flow generator.

12. The system of claim 11, wherein the third light source and the fourth light source are disposed on opposite sides of a travel path of the grow towers.

13. The system of claim 1, wherein a fifth light source of the plurality of light sources is disposed adjacent to a first wall of the plurality of walls.

14. The system of claim 13, wherein a sixth light source of the plurality of light sources is disposed adjacent to a second wall of the plurality of walls opposite the first wall.

15. The system of claim 1, wherein the plurality of walls comprise an opaque material.

16. The system of claim 1, wherein each grow tower of the plurality of grow towers is coupled to the grow line by a hook.

17. A pollination system, comprising:
a plurality of walls;
a first flow generator disposed adjacent to the plurality of walls and configured to generate a first air curtain;
a second flow generator disposed adjacent to the plurality of walls and configured to generate a second air curtain, the second air curtain disposed opposite the first air curtain, wherein the plurality of walls, the first air curtain, and the second air curtain define a volume; and
a plurality of light sources disposed in the volume.

18. The system of claim 17, wherein the plurality of light sources are ultraviolet light sources.

19. The system of claim 18, wherein the ultraviolet light sources are light emitting diodes.

20. A pollination system, comprising:
a grow line having a plurality of grow towers disposed thereon; and
a pollination chamber, comprising:
a plurality of walls at least partially defining a volume;
a first flow generator positioned adjacent to the plurality of walls;
a second flow generator positioned adjacent to the plurality of walls and opposite the first flow generator; and
a plurality of light sources disposed within the pollination chamber, the plurality of light sources comprising:
a plurality of light source pairs, wherein a first light source of a pair is disposed above the grow towers and a second light source of the pair is disposed below the grow towers, and wherein the plurality of light source pairs are positioned within the volume along a travel path of the grow towers.
